(19) United States
(12) Patent Application Publication
(10) Pub. No.: US 2005/0044782 A1
(43) Pub. Date: Mar. 3, 2005

(54) Culture medium

(75) Inventors: Tetsuo Kuroda, Chigasaki-shi (JP); Hidemitsu Otsuka, Tokyo (JP); Yuzo Narasaki, Yokohama-shi (JP); Ichiro Kamiya, Tokyo (JP); Itaru Umeda, Yokohama-shi (JP); Hideaki Hayashi, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: EBARA CORPORATION, Tokyo (JP)

(21) Appl. No.: 10/937,552

(22) Filed: Sep. 10, 2004

Related U.S. Application Data
(63) Continuation of application No. 10/110,207, filed on Apr. 18, 2002, now abandoned.

(30) Foreign Application Priority Data
Oct. 19, 1999 (JP) 11-296931
Dec. 28, 1999 (JP) 11-374011

(51) Int. Cl. A01G 23/10

(52) U.S. Cl. 47/10

(57) ABSTRACT

The invention aims at providing a pumice-based culture medium which shows outstanding characteristics as a culture medium to be used in protected horticulture. To this end, the invention provides a culture medium comprising particulate pumice having a saturated water permeability of 0.3-0.8 cm/sec and an air permeability of 15-40 cm/sec in both a dry sample and a wet sample. In another embodiment, the invention provides a culture medium having charcoal added to a culture medium comprising the particulate pumice having the above-described physical properties.

### TECHNICAL FIELD

This invention relates to culture mediums, more particularly, to culture mediums suitable for protected horticulture of vegetables, fruit trees, flowering plants, etc. using less water and resources. Since the culture mediums of the invention permit moisture adjustment, they can be used to cultivate field crops of added value by, for example, raising the sugar content of vegetable fruits, in particular, tomato and melon.

### BACKGROUND ART

High-grade vegetables such as corn salad and tomato are usually grown in crop fields but sometimes they need to be cultivated in open-area facilities and greenhouses with the environment being precisely controlled as in industrial plants. This cultivation method is called “protected horticulture”.

Among the highly productive methods of growing high-grade vegetables and fruit trees by protected horticulture is cultivation with nutrient solution. The methods of cultivation with nutrient solution are classified by medium type, solid medium and non-solid medium. Methods of cultivation on solid mediums include sand culture, gravel culture and smoked coal culture. In the respective methods, sand particles, gravel stones and smoked coal are laid down to make mediums which are constantly sprinkled with aqueous nutrient solution.

The conventional solid medium approach has had the problem of involving very cumbersome steps in cultivating. Plants find difficulty in taking root in sand or gravel mediums and only low yield results. In addition, plants easily catch disease unless they are put under constant surveillance. What is more, water management is quite difficult and over-irrigation or under-irrigation often occurs.

Various kinds of medium are currently under review to find candidates that meet specific uses and objects in protected horticulture and it has been proposed to use pumice as the culture medium for several reasons such as absence of the need to use large quantities of nutrient solution and a smaller likelihood for catching disease from stagnant nutrient solution. However, no studies have yet been made to determine the physical properties and particle size of pumice stones which are suitable for use as culture mediums in protected horticulture.

The present invention has been accomplished under these circumstances and relates principally to the use of pumice as a culture medium in protected horticulture by the solid medium approach. It is therefore an object of the invention to provide a culture medium that has optimum physical properties and particle size, which involves little labor in cultivating, and which permits easy water management without letting out effluents in almost all cases.

### DISCLOSURE OF THE INVENTION

This object of the invention can be attained by a culture medium comprising particulate pumice having a saturated water permeability of 0.3-0.8 cm/sec and an air permeability of 15-40 cm/sec in both a dry sample and a wet sample.

While various culture mediums are available, one which is made of particulate volcanic pumice permits good water permeation, is lightweight and non-sticky, offering the advantage of facilitating the steps in the cultivation process. Compared to the soil, the particulate pumice medium supplies less nutrients to the rhizosphere and can retain only small amounts of fertilizer ingredients; on the other hand, the particulate pumice medium has the advantage that if it is supplied with an appropriate amount of nutrient liquor by means of a dropping tube, it can maintain the appropriate moisture condition by supplying droplets in amounts substantially equal to the evaporation of water from the isolated bed including the crop. As a result, crops can be cultivated with minimum use of water and energy.

Pumice is a type of glassy rock that has been made to have a multiple of vesicles by the release of volatile components from felsitic magma as of rhyolite and andesite due to a sudden pressure drop after it has been violently ejected from volcanos; on appearance, pumice is frothy and has many small holes in the surface. Pumice is usually distinguished by the place of production since its physical properties vary with the type of the rock from which it originates. Andesite-based pumice is predominantly black whereas rhyolite-based pumice is white to pale gray and more porous than andesite-based pumice.

The present inventors studied various characteristics of pumice as a candidate for the culture medium that is to be used in the solid medium approach. They particularly noted saturated water permeability and air permeability and found that excellent culture mediums could be provided by using pumice having a saturated water permeability of 0.3-0.8 cm/sec and an air permeability of 15-40 cm/sec in both a dry sample and a wet sample. The present invention has been accomplished on the basis of this finding. Culture mediums comprising the particulate pumice having the above-specified values of physical properties provide ideal environmental conditions for the roots of crops to absorb water and breathe; in addition, aerobic conditions are sufficiently maintained in the mediums to suppress the growth of anaerobic microorganisms and the manifestation of root diseases.

### BRIEF DESCRIPTION OF THE DRAWINGS

FIG. 1 shows in conceptual form a soil water permeability meter which is used to measure the saturated water permeability of soil by the constant head method as defined in the invention;

FIG. 2 shows in conceptual form an air permeability meter which is used to measure the air permeability of soil as defined in the invention;

FIG. 3 is a micrograph of SHIRASU pumice at a magnification of 500;

FIG. 4 is a micrograph of a sand particle at a magnification of 500;

FIG. 5 shows schematically the cultivation test equipment used in Example 1 of the invention; and

FIG. 6 is a graph showing the result of the cultivation test conducted in Example 2 of the invention.

### BEST MODE FOR CARRYING OUT THE INVENTION

As described above, the culture medium of the invention is characterized by comprising particulate pumice having a saturated water permeability and an air permeability within the specified ranges.

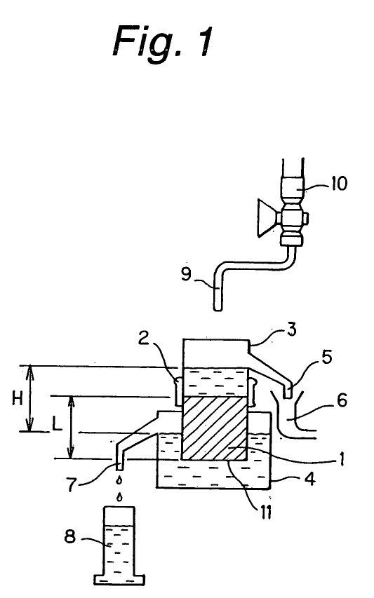

The pumice used to make the culture medium of the invention has preferably a saturated water permeability in the range of 0.3-0.8 cm/sec. If the saturated water permeability is less than 0.3 cm/sec, water diffuses so slowly that moisture is distributed unevenly in the medium and the old culture liquor becomes stagnant to increase the chance of damaging plant roots. If the saturated water permeability exceeds 0.8 cm/sec, water diffuses so fast that it soon flows out of the medium to present difficulty in supplying adequate water or nutrients. The concept of “saturated water permeability” is explained in, for example, “Dojo Kankyo Bunsekiho (Analyses of Soil Environment)”, ed. by the Editors' Committee on Analyses of Soil Environment under the supervision of the Society of Soil and Fertilizers of Japan, published by Hakuyusha, first printing in 1997, pp. 66-69. The saturated water permeability as specified in the invention is determined by the constant head method. FIG. 1 shows in conceptual form an example of a soil water-permeability measuring instrument (e.g. DIK-4000 of Daiki Rika Kogyo Co., Ltd.) that is used to measure saturated water permeability by the constant head method. A sample of soil to be analyzed is packed in a cylinder 1. To the top of the cylinder 1, a constant water level holder 3 is connected by means of a rubber ring 2. The soil-filled cylinder 1 is placed in a water tank 4 and a drain port 5 of the constant water level holder 3 is positioned above a drain pipe 6 in order to drain surplus water. The bottom of the soil-filled cylinder 1 is stoppered with screen cap 11. A measuring cylinder 8 is put below a drain port 7 of the water tank; a swing nozzle 9 is positioned above the constant water level holder 3; and supply of water through a pipe 10 starts. In order to ensure that the surface of the sample soil is not upset by the water being supplied, the soil surface is protected with filter paper or the like. The water to be supplied has ordinary temperature. To keep a constant water level in the constant water level holder, the amount of water being supplied is adjusted appropriately by means of a cock on the swing nozzle 9. The volume of water Q (mL) flowing into the measuring cylinder within a given time t (sec) is measured. The measurement is conducted two or three times.

The saturated water permeability (cm/sec) of the sample is calculated as coefficient K by the following equation:
K=Q/{(A·t·H)/L} (1)
wherein Q is the amount of flow (ml), A is the cross-sectional area (cm²) of the sample, t is time (sec), H is the level difference (cm), and L is the thickness (cm) of the sample.

The pumice used to make the culture medium of the invention has preferably an air permeability of 15-45 cm/sec, more preferably 20-30 cm/sec, in both a dry sample and a wet sample. If the air permeability of the pumice is less than 15 cm/sec, less oxygen is supplied to the roots, potentially promoting the growth of anaerobic microorganisms that attack plants. An air permeability in excess of 40 cm/sec presents no problem to the supply of oxygen but, on the other hand, the porosity is so high as to reduce the tendency of roots to have intimate contact with the medium. The “wet sample” is a sample that has just been left to stand for 24 hours in a water-saturated state.

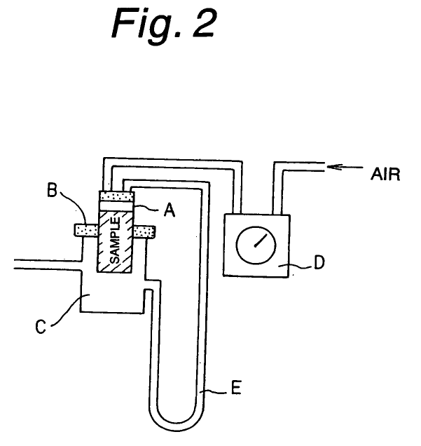

The concept of “air permeability” is described in, for example, “Dojo Butsurisei Sokuteiho (Methods for Measuring the Physical Properties of Soil)”, ed. by the Committee on Methods for Measuring the Physical Properties of Soil under the supervision of the Secretariat for the Conference on the Technology of Agriculture and Forestry, Ministry of Agriculture and Forestry, published by Yokendo, Vol. 2 in two volumes, pp. 270-273. FIG. 2 shows in conceptual form an apparatus for measuring the air permeability of soil. Actual measurements may be performed with a soil air-permeability measuring instrument DIK-5001 of Daiki Rika Kogyo Co., Ltd. In FIG. 2, a sample-filled cylinder A is tightly penetrated through a thick rubber plate B. The rubber plate B is placed on a glass vessel C in such a way as to keep sufficient airtigtness in its interior. With the difference between the pressure at the entrance to the sample and the pressure at the exit (P2−P1) (head in cm) being measured with an aquatic manometer E, a given volume (Q cm³) of air is passed into the sample as it is measured with a gas meter D and the time of air permeation t (sec) is measured. If the area of the flow channel is written as A (cm²) and its length as L (cm), the air permeability Ka (cm/sec) is determined by the following equation:
Ka=Q×L/{(P2−P1)×A·t} (2)

The pumice used to make the culture medium of the invention more preferably has a cation-exchange capacity of 3.0-4.0 meq/100 g. In this specification, meq/100 g means milli-equivalents per 100 g of dry soil. If the cation-exchange capacity of the pumice is less than 3.0 meq/100 g, it has such a small fertilizer holding capacity that the crop yield decreases. The inherent nature of pumice is such that it seldom has a cation-exchange capacity in excess of 4.0 meq/100 g. Measurement of cation-exchange capacity can be effected by the semimicro Schollenberger method described on pages 208-210 of “Dojo Kankyo Bunsekiho (Analyses of Soil Environment)”, supra (the Schollenberger method using 1 M ammonium acetate at pH of 7.0 is scaled down by a factor of 10). According to the Schollenberger method, a soil column is prepared in a permeation tube, treated with ammonium acetate so that the exchangeable cations in the soil are eluted upon exchange with NH₄⁺; thereafter, the soil is treated with ethanol to wash the surplus ammonium acetate off, then treated with an aqueous solution of sodium chloride to elute the NH₄⁺; the eluted NH₄⁺ is quantified by a suitable technique such as the distillation of water vapor, titration, etc. and the amount of the adsorbed NH₄⁺ is a measure of the cation exchange capacity of the soil.

As a result of their studies, the present inventors have found that in most of the cases where it has particle sizes in the range of 1.0-5.6 mm, pumice has appropriate levels of water permeability, air permeability and cation exchange capacity within the ranges specified above. In particular, the SHIRASU pumice found in Kagoshima Prefecture, Japan has been found to have appropriate levels of water permeability, air permeability and cation exchange capacity within the ranges specified above if it has particle sizes within the stated range.

Consider, for example, pumice particles no larger than 1.0 mm; they have an air permeability of about 10 cm/sec in a dry sample and a value of 2-5 cm/sec in a wet sample. Hence, the air permeability of the pumice particles no larger than 1.0 mm is very low, particularly when they are in a wet state. Within the range of 1.0-5.6 mm, both a dry sample and a wet sample have consistently high air permeabilities.

Size classification may be performed using standard test sieves-described in JIS Z8801. Pumice particles with sizes of 1.0-5.6 mm pass through a sieve having a nominal size of 5.6 according to JIS Z 8801 but do not pass through a sieve having a nominal size of 1.0. Sieving may be carried out in the usual manner and a specific size value refers to the size of the practically dominant particles. Inclusion of fine particles in 10 vol % or less of the total weight is not a problem and pumice having this feature is included within the scope of the invention.

The pumice used to make the culture medium of the invention preferably has a particle size of 1.0-5.6 mm, a saturated water permeability of 0.3-0.8 cm/sec, and an air permeability of 15-40 cm/sec in both a dry sample and a wet sample. More preferably, the pumice used to make the culture medium of the invention has a particle size within the stated range and a cation exchange capacity of 3.0-4.0 meq/100 g. The cation exchange capacity of pumice having a particle size of less than 1.0 mm often drops below 1.0 meq/100 g.

The definition of SHIRASU pumice as well as its description may be found in “Tsuchi no Kankyoken (Environment of Soil)”, ed. under the supervision of Shingo Iwata, published by Fuji-Techno System, 1997, pp. 30-32. According to the definition, SHIRASU pumice is the generic name for “non-fused portions of the deposits of pyroclastic pumice flows ejected from large caldera volcanos in the late Pleistocene, or secondary deposits of such portions”. In Japan, the SHIRASU from the southern part of Kyushu is famous. SHIRASU of the same nature is also distributed around Lake Kussharo, Lake Shikotsu, Lake Toya and Lake Towada, as well as around caldera volcanos such as Mt. Tokachidake and Mt. Aso. In surface layer geological maps such as those prepared by the National Land Agency in a basic survey of land classifications, SHIRASU is shown as the deposits of pumice flows.

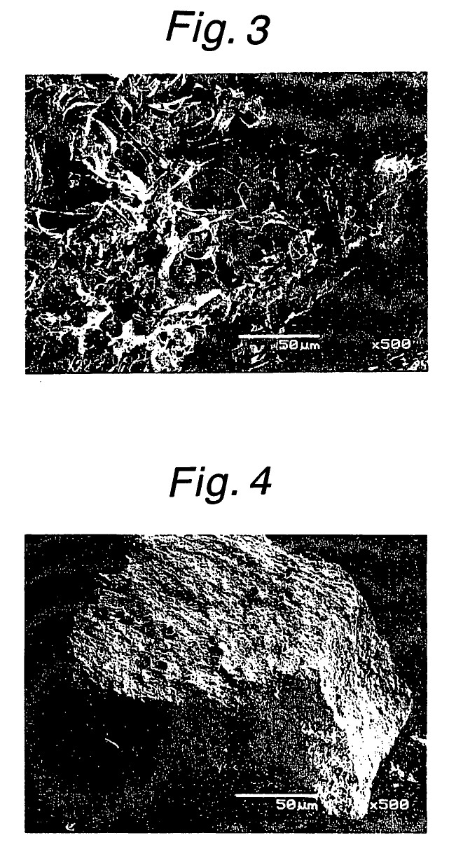

FIG. 3 is a micrograph (×500) of SHIRASU pumice, and FIG. 4 is a micrograph (×500) of a sand particle. Comparing FIGS. 3 and 4, one can clearly see the porosity of SHIRASU pumice.

As mentioned above, it is more preferred that the pumice used to make the culture medium of the invention is mined, classified to have a particle size within the range of 1.0-5.6 mm and immediately dried to a moisture content of 0.4% and less. Therefore, according to its another aspect, the invention relates to a culture medium comprising pumice that has been mined as particles having a saturated water permeability of 0.3-0.8 cm/sec and an air permeability of 15-40 cm/sec in both a dry sample and a wet sample and which is thereafter dried to a moisture content of 0.4% and less.

Pumice as mined has organic matter or microorganisms deposited in voids, either inherently or during handling, and this may sometimes cause adverse effects on cultivation or unstabilize the physical and chemical properties of the pumice. By drying the as-mined pumice, not only its physical and chemical properties are stabilized but also the growth of microorganisms is prevented, thus providing cultural mediums capable of maintaining consistent quality. Drying can be effected by means of either a heating furnace or a microwave oven. If a heating furnace is used, the pumice should be heated to at least 105° C., preferably to about 250° C. If a microwave oven is used, it should be of an industrial type capable of producing high output power. The heating time should be long enough to lower the moisture content of the pumice to 0.4% or less. Since the initial moisture of pumice is oftentimes variable, longer heating times are desirably chosen to take the safe side. The pumice as dried is desirably stored in a bag made of a moisture-barrier material such as vinyl resins into which it is put after it has cooled to ordinary temperature.

The moisture content of soil is represented by the following equation:
Moisture content (wt %)=(moisture weight/wet soil weight)×100 (3)
where moisture weight is equal to wet soil weight minus dry soil weight, and dry soil weight is the weight of a soil sample that has been dried at 105° C. for 24 hours. For the definition of dry soil weight, see the description on pages 21-23 of “Dojo Kankyo Bunsekiho”, supra.

The present inventors also found that a culture medium more suitable for large-scale cultivation can be provided by mixing particulate charcoal with the culture medium formed of particulate pumice having the above-specified physical properties. The mixed medium has substantially the same physical and chemical properties as the pumice medium and it still has greater capacity to hold water and fertilizer, thus allowing for faster growth of seedlings after they are transplanted for setting. Therefore, in yet another embodiment, the invention relates to a culture medium characterized by incorporating charcoal in the medium composed of the above-specified particulate pumice.

The particulate charcoal that can be used in the invention may be of any type as long as it is prepared by dry distillation of various organic materials. From the viewpoint of the capacity to hold water and fertilizer, particulate charcoal of grades having high porosity is preferred. Examples of the charcoal that can preferably be used in the preferred embodiment of the invention include wood coal, bamboo coal and chaff coal. The purpose of adding charcoal in the preferred embodiment of the invention is to compensate for the relatively small fertilizer holding capacity of volcanic pumice, so it is preferred to use charcoal that is highly porous and which has high capacity to hold water and fertilizer. Using charred agricultural by-products such as brewer's grains is very preferred since this contributes to effective use of wastes. From the viewpoint of effective use, the charcoal is preferably recirculated in the preferred embodiment of the invention.

The particle size of the charcoal may be comparable to that of the pumice and its exact size can be chosen as appropriate for its porosity and its content relative to the pumice. The preferred size of the charcoal is in the range of 1-5.6 mm and its average size is variable with a specific situation. The preferred charcoal is such that it mixes uniformly with the pumice.

The relative proportions of the pumice and the charcoal can be chosen at various values as they relate to the crop to be cultivated. Generally speaking, the charcoal is used in masses which are from one tenth to one half the mass of the pumice.

The following examples are provided to further illustrate various embodiments of the invention but are in no way to be taken as limiting the scope of the invention.

### EXAMPLE 1

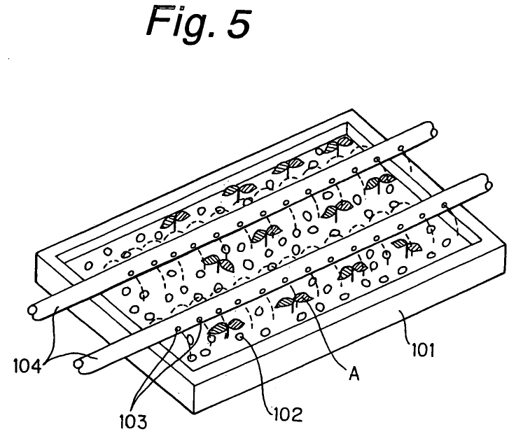

FIG. 5 shows in conceptual form the cultivator used in Example 1. A cultivation box 101 which was 450 mm wide by 1200 mm long was filled with an 80-mm deep bed of SHIRASU pumice 102 produced in Kagoshima Prefecture, Kyushu, Japan, and corn salad A was cultivated in July and August. The cultivation test was performed in Shizuoka Prefecture. The SHIRASU pumice 102 had been classified to sizes of 1.0-5.6 mm using a 5660-μm sieve and a 1000-μm sieve and dried at 250° C. for 4 hours in a heating furnace. The moisture content of the pumice was 0.2%. The pumice had a saturated water permeability of 3.4×10⁻¹ cm/sec, air permeabilities of 19 cm/sec (dry sample) and 27 cm/sec (wet sample), and a cation exchange capacity of 3.4 meq/100 g. Perforated irrigation pipes 104 were positioned horizontally over and across the culture box 101 and the SHIRASU pumice 102 was sprinkled with water as appropriate. Each irrigation pipe 104 had small holes 103 in the sidewall that were opened in a row at given spacings.

Two days after seeding, germination was confirmed and 10 days later, the seedlings were transplanted into the cultivation box in a greenhouse for setting. The planted area was 20 m². Under illumination with sunlight, nutrients (liquid fertilizer) and water were supplied continuously. Thirty days after transplantation, the yield was 36 plants per square meter. The weights of 12 plants excluding the root were measured and the results are shown in Table 1.

TABLE 1
Results of Corn Salad Cultivation in Example 1

| Plant | Plant weight | Plant diameter | Number of | Core weight |
|---|---|---|---|---|
| No | (g) | (cm) | leaves | (g) |
| 1 | 100 | 19 | 42 | 8 |
| 2 | 116 | 21 | 42 | 14 |
| 3 | 105 | 18 | 47 | 10 |
| 4 | 112 | 23 | 41 | 10 |
| 5 | 116 | 21 | 47 | 10 |
| 6 | 108 | 21 | 43 | 11 |
| 7 | 92 | 18 | 46 | 12 |
| 8 | 98 | 19 | 42 | 12 |
| 9 | 105 | 20 | 35 | 11 |
| 10 | 107 | 22 | 41 | 12 |
| 11 | 116 | 21 | 42 | 15 |
| 12 | 140 | 21 | 39 | 9 |

### COMPARATIVE EXAMPLE 1

A corn salad cultivation test was performed as in Example 1, except that the SHIRASU pumice was replaced by sand having the following properties: particle size, 0.2-1.0 mm; moisture content, 0.5 wt %; saturated water permeability, 3.7 cm/sec; air permeability, 59 cm/sec (dry sample) and 63 cm/sec (wet sample); cation exchange capacity, 0.9 meq/100 g. The planted area was 10 m². The yield was 22 plants per square meter. The weights of 12 plants were measured and the results are shown in Table 2. The average weight of the 12 plants was 82.9 g.

TABLE 2
Results of Corn Salad Cultivation in Comparative Example 1

| Plant | Plant weight | Plant diameter | Number of | Core weight |
|---|---|---|---|---|
| No | (g) | (cm) | leaves | (g) |
| 1 | 76 | 16 | 35 | 7 |
| 2 | 82 | 17 | 37 | 8 |
| 3 | 77 | 16 | 33 | 8 |
| 4 | 90 | 18 | 39 | 9 |
| 5 | 69 | 16 | 34 | 7 |
| 6 | 72 | 17 | 33 | 7 |
| 7 | 88 | 18 | 36 | 8 |
| 8 | 92 | 18 | 38 | 9 |
| 9 | 101 | 19 | 40 | 10 |
| 10 | 74 | 17 | 35 | 7 |
| 11 | 81 | 18 | 34 | 8 |
| 12 | 93 | 18 | 37 | 9 |

Obviously, by using the pumice medium of the invention, not only the planting density of corn salad but also the weight of each plant could be increased.

### COMPARATIVE EXAMPLE 2

A comparative sample of SHIRASU pumice produced in Kagoshima Prefecture was classified to a size of less than 1 mm by sieving. It had a saturated water permeability of 2.5×10⁻² cm/sec which was less than a tenth of the value for the sample of SHIRASU pumice used in Example 1. The air permeability of the comparative sample was 12 cm/sec in a dry state and 4 cm/sec in a wet state; the air permeability of the wet sample was particularly low. The cation exchange capacity of the comparative sample was 1.3 meq/100 g.

### EXAMPLE 2

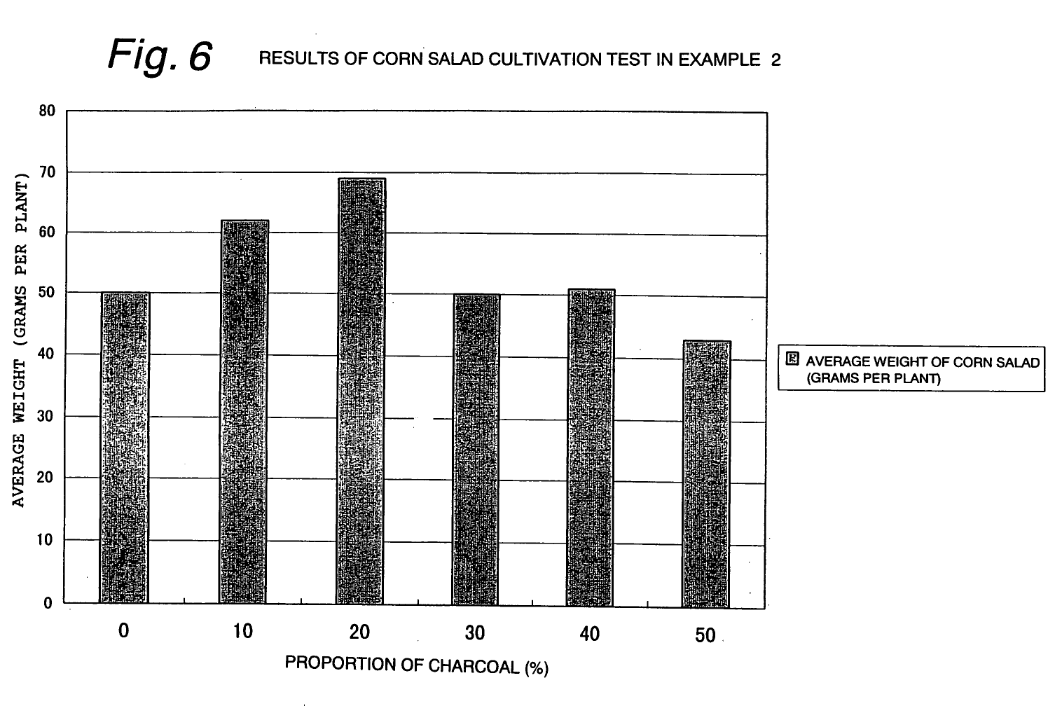

A cultivation test was performed on mediums comprising a mixture of pumice and charcoal. The pumice was the same as the sample of SHIRASU pumice used in Example 1. Charcoal (charred coconut husk) was ground to sizes of 1-2 mm; the SHIRASU pumice was mixed with the particulate charcoal in varying weights to prepare the following six mediums: A (0% of charcoal); B (10%); C (20%); D (30%); E (40%); and F (50%). Corn salad was cultivated in each medium. Cultivation was performed in Okinawa Prefecture. Sowing was done at the end of May; at 17 days of the sowing, the seedlings were transplanted for setting and the crops were harvested 32 days later. Drip watering was performed continuously; the supply rate was 50 mL/plant during nursing of the seedlings and 60 mL/plant after transplantation. A liquid fertilizer was applied. From each of the mediums tested, 21 plants were harvested and the average weight of corn salad per plant excluding the root was determined. The results are shown in Table 3 and FIG. 6.

TABLE 3
Results of Corn Salad Cultivation in Example 2

| | Proportion of | Average weight of |
|---|---|---|
| Medium | charcoal (%) | corn salad (g/plant) |
| A | 0 | 50 |
| B | 10 | 62 |
| C | 20 | 69 |
| D | 30 | 50 |
| E | 40 | 51 |
| F | 50 | 43 |

Obviously, the average weight of the corn salad cultivated on medium C comprising a mixture of pumice and 20% charcoal was almost 20 grams greater than for the corn salad cultivated on medium A containing no charcoal.

### EXAMPLE 3

A continuous cropping test was performed on mediums comprising a mixture of pumice and charcoal. The pumice was the same as the sample of SHIRASU pumice used in Example 1. Charcoal (charred coconut husk) was ground and classified to have the same size range as the SHIRASU pumice (1-5.6 mm); the SHIRASU pumice was mixed with the particulate charcoal in varying weights to prepare the following seven mediums: A (0% of charcoal); B (10%); C (20%); D (30%); E (50%); F (80%); and G (100%). A portion (800 g) of each mixed medium was sampled per pot, put into a 1-L Pyrex beaker and used as a medium for cultivating Brassica Rapa var. pervidis. Cultivation was performed in Shizuoka Prefecture. Ten days after sowing, the seedlings were transplanted for setting and about 30 days later, the crops were harvested. In this way, continuous cropping was done through ten cycles. The nutrient liquor used was based on river water and supplemented with necessary nutrients at substantially the same concentrations as those of a standard recipe recommended by a horticultural experiment station [N=16 (meq/L as applicable hereinafter); P=4; K=8; Ca=8; Mg=4]. To all mediums, the nutrient liquor conditioned in a single tank was supplied on the same timing in the same amount. Throughout the test period, all mediums were protected in a greenhouse. The weights of the harvested plants of Brassica Rapa var. pervidis were measured and the results are shown in Table 4 as the average for ten plants.

TABLE 4
Results of Brassica Rapa var. pervidis Cultivation
in Example 3 (plant weight in grams)

| | | Cycles of | | | | | | | | | | |
|---|---|---|---|---|---|---|---|---|---|---|---|---|
| | Proportion of | continuous cropping | | | | | | | | | | |
| Medium | charcoal, wt % | 1 | 2 | 3 | 4 | 5 | 6 | 7 | 8 | 9 | 10 | Average |
| A | 0 | 41 | 45 | 43 | 46 | 50 | 52 | 46 | 43 | 41 | 38 | 44.5 |
| B | 10 | 44 | 47 | 44 | 49 | 53 | 55 | 55 | 50 | 47 | 43 | 48.7 |
| C | 20 | 49 | 52 | 51 | 50 | 56 | 59 | 49 | 55 | 57 | 50 | 52.8 |
| D | 30 | 46 | 49 | 47 | 51 | 50 | 53 | 52 | 51 | 49 | 48 | 49.6 |
| E | 50 | 47 | 50 | 42 | 44 | 51 | 49 | 52 | 43 | 41 | 34 | 45.3 |
| F | 80 | 39 | 41 | 39 | 43 | 44 | 47 | 35 | 38 | 34 | 32 | 39.2 |
| G | 100 | 40 | 43 | 39 | 47 | 42 | 41 | 38 | 37 | 39 | 33 | 39.9 |

Obviously, mediums B-E containing 10-50 wt % of charcoal were more productive than medium A solely consisting of SHIRASU pumice without injury of continuous cropping.

### Industrial Applicability

The culture medium of the invention is characterized by comprising particulate pumice having a saturated water permeability of 0.3-0.8 cm/sec and an air permeability of 15-40 cm/sec in both a dry sample and a wet sample and very suitable for use in the cultivation, particularly protected horticulture, of plants. Specific examples of the plants that can be cultivated on the medium of the invention include vegetables, fruit trees and flowering plants. Among these, corn salad and Brassica Rapa var. pervidis which are suited to protected horticulture are worth particular mentioning. In a preferred embodiment of the invention, the culture medium is mixed with charcoal to have greater capacity to hold water and fertilizer and cultivation can be repeated over a prolonged period without injury of continuous cropping; this contributes to simplifying farm practices. As another advantage, the frequency of changing polluted mediums is sufficiently decreased to reduce the economic burden of disposing of spent mediums. The culture medium of the invention assures consistent yield in protected horticulture and is very favorable to planned production which is the principal objective of protected horticulture.

1-5: (Canceled).

6: A method for forming a medium for protected horticulture of plant composed of a particulate volcanic pumice, comprising classifying mined volcanic pumice, heating and drying the classified volcanic pumice, storing the dried volcanic pumice in a bag made of a moisture-barrier material, and paving a protected horticulture facility with the stored volcanic pumice to form a medium having a saturated water permeability of 0.3-0.8 cm/sec and an air permeability of 15-40 cm/sec.

7: The method of claim 6 wherein the classified mined volcanic pumice has a size of 1.0-5.6 mm.

8: The method of claim 6 wherein drying of the classified volcanic pumice is conducted at a temperature of at least 105° C. to provide pumice having a moisture content of 0.4% or less.

9: The method of claim 6 wherein the medium has a cation exchange capacity of 3.0-4.0 meq/100 g.

10: The method of claim 6 wherein the volcanic pumice is SHIRASU pumice.

11: The method of claim 6 wherein the medium further contains a particulate charcoal.

12: The method of claim 11 wherein the amount of the particulate charcoal ranges from 1/10 to ½ the mass of the pumice.
